(19) United States
(12) Patent Application Publication
(10) Pub. No.: US 2010/0053191 A1
(43) Pub. Date: Mar. 4, 2010

(54) SYSTEM AND METHOD FOR COMPUTING AND DISPLAYING A ROUNDNESS ERROR OF AN OBJECT

(75) Inventors: CHIH-KUANG CHANG, Tu-Cheng (TW); LI JIANG, Shenzhen City (CN); YONG-HONG DING, Shenzhen City (CN); XIAN-YI CHEN, Shenzhen City (CN); DONG-HAI LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (SHENZHEN) CO., LTD., Shenzhen City (CN); HON HAI PRECISION INDUSTRY CO., LTD., Tu-Cheng (TW)

(21) Appl. No.: 12/338,959

(22) Filed: Dec. 18, 2008

(30) Foreign Application Priority Data
Sep. 3, 2008 (CN) 200810304347.X

(51) Int. Cl. G09G 5/02

(52) U.S. Cl. 345/589

(57) ABSTRACT

A method and system for computing and displaying a roundness error of an object specifies different colors that respectively represents an error range of points. The method and system receives a point cloud of the object and fits a circle based on the point cloud. The method and system computes an error of each point in the point cloud by computing a distance between the each point and the circle, colorizes the points in the point cloud according to the errors and the specified colors, and generates and outputting a graphic roundness error analysis report.

### BACKGROUND

1. Technical Field

Embodiments of the present disclosure generally relate to measurement systems and methods, and more particularly, to a system and method for computing and displaying a roundness error.

2. Description of Related Art

It is often necessary to measure the non-roundness of a circular part. This is important because an unacceptable degree of non-roundness of a part can affect how that part couples with other parts or otherwise performs when assembled to other parts.

A method for measuring roundness errors uses image processing techniques. In one such method, a point cloud that makes up an image of the circular part is made, electronically processed, and quantified using image processing algorithms. Using the method, a numerical roundness error analysis report is generated. However, the numerical roundness error analysis report is not very visual, and a real position of each point in the point cloud may not be shown clearly. Thus, analysis of the roundness error may be difficult.

Thus, a system and method for overcoming the aforementioned problem is needed.

### BRIEF DESCRIPTION OF THE DRAWINGS

FIG. 1 is a block diagram of one embodiment of a system for computing and displaying a roundness error of an object;

FIG. 2 is a block diagram of one embodiment of function modules of the system in FIG. 1;

FIG. 3 is a flowchart illustrating one embodiment of a method for computing and displaying a roundness error of an object; and

FIG. 4A and FIG. 4B respectively illustrates a circle and a line transformed from the circle.

### DETAILED DESCRIPTION OF CERTAIN INVENTIVE EMBODIMENTS

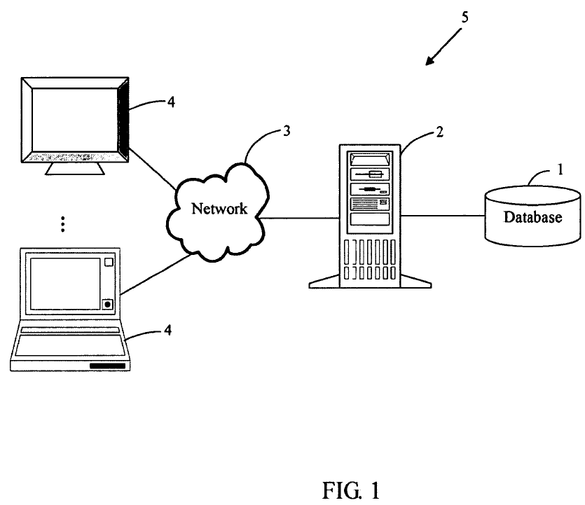

FIG. 1 is a block diagram of one embodiment of a system 5 for computing and displaying a roundness error of an object. It may be understood that, the object is an object having circular dimensions on at least one section of the object. In one embodiment, the system 5 may comprise an application server 2. The application server 2 connects to at least one client computer 4 (two shown) via a network 3. The network 3 may be the Internet, an intranet, or any other suitable network. The client computer 4 provides a user interface (UT) for displaying a graphic roundness error analysis report. The application server 2 may further connect to a database 1 via a database connection (not shown). The database 1 may store point clouds that are derived by scanning the object, namely the circular part of the object, whose roundness error need to be measured.

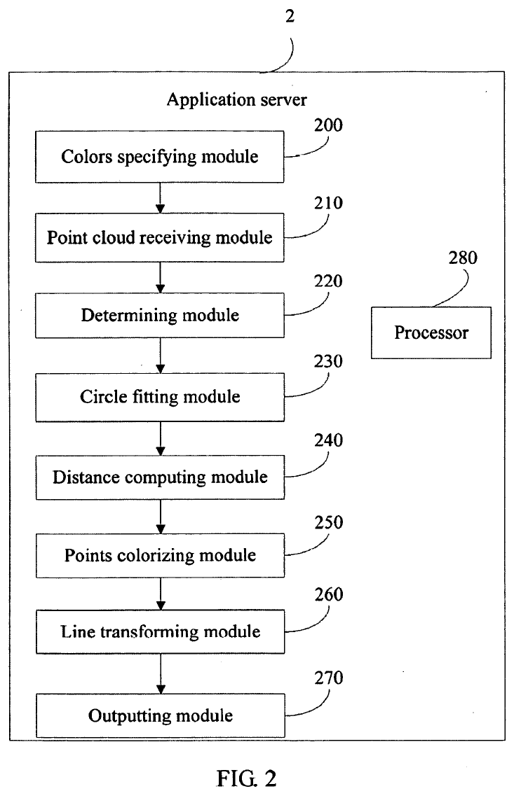

FIG. 2 is a block diagram of one embodiment of function modules of the application server 2 in FIG. 1. In one embodiment, the application server 2 includes a colors specifying module 200, a point cloud receiving module 210, a determining module 220, a circle fitting module 230, a distance computing module 240, a points colorizing module 250, a line transforming module 260, and an outputting module 270. It may be understood that, one or more specialized or general purpose processors, such as a processor 280, in the application server 2, can execute the function modules 200, 210, 220, 230, 240, 250, 260, and 270.

The colors specifying module 200 is configured for specifying a plurality of different colors with each of the colors representing a specific error range of a point. It may be understood that, the error range of a point restricts a tolerable distance between the point and a reference point, a reference line, a reference circle, and so on. For example, the color specifying module 200 may specify red for an error range of 0.001 mm-0.005 mm, specify yellow for an error range of 0.006 mm-0.010 mm, and so on.

The point cloud receiving module 210 is configured for receiving at least one point cloud of the object from the database 1. It may be understood that, a point cloud is a set of vertices in a three-dimensional coordinate system. These vertices are usually defined by X, Y, and Z coordinates. Point clouds are most often created by three-dimensional (3D) scanners. The 3D scanners measure a large number of points on the surface of an object, and output a point cloud as a data file. The point cloud represents the visible surface of the object that has been scanned or digitized.

The determining module 220 is configured for determining if a circle can be fitted using the point cloud. It may be understood that, if a number of points in the point cloud is less than 3, a circle cannot be fitted using the point cloud, or if all points in the point cloud are in a straight line, a circle cannot be fitted using the point cloud.

The circle fitting module 230 is configured for fitting a circle based on the points in the point cloud using a least square method.

The distance computing module 240 is configured for computing an error of each point in the point cloud. In one embodiment, the distance computing module 240 firstly computes a first distance between the each point in the point cloud and the center of the circle, and then computes a second distance by subtracting the radius of the circle from the first distance. It may understood that the second distance is the error.

The points colorizing module 250 is configured for colorizing the points in the point cloud according to the errors of the points and the specified colors. In one embodiment, for example, if an error of a point in the point cloud is 0.004, which falls in the error range of 0.001 mm-0.005 mm, the points colorizing module 250 assigns red to the point. If an error of a point in the point cloud is 0.007, which falls in the error range of 0.006 mm-0.00 mm, the points colorizing module 250 assigns yellow to the point.

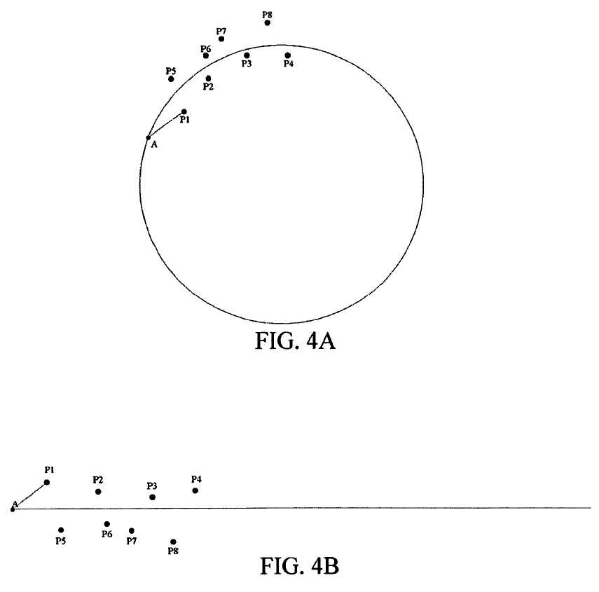

The line transforming module 260 is configured for transforming the circle into a line by selecting a point on the circle as an endpoint of the line, and arranging the points in the point cloud according to a third distance between each of the points and the selected point. It may be understood that, the circle is fitted according to the point cloud using the least square method, thus, the points in the point cloud are around the circle, like which is shown in FIG. 4A. For visually and clearly displaying an error of each point in the point cloud, for example, displaying which point has a maximum error, and which point has a minimum error, the circle is best transformed into a line, and the point cloud is best arranged around the line, like which is shown in FIG. 4B. From FIG. 4B, it can be clearly seen that, a point “P3” has a minimum error, and a point “P8” has a maximum error. Accordingly, the line transforming module 260 selects a point “A” on the circle, splits the circle at the selected point “A”, and generates a line by pulling the split circle straight and taking the selected point “A” as an endpoint of the line. In addition, the line transforming module 260 computes the third distance between each point in the point cloud, for example, a point “P1,” and the selected point “A”, and arranges all points in the point cloud around the line according to the third distances.

The outputting module 270 is configured for generating a graphic roundness error analysis report comprising the specified colors, the circle, the colorized points, the line, and the point cloud. The outputting module 270 is further configured for outputting the graphic roundness error analysis report.

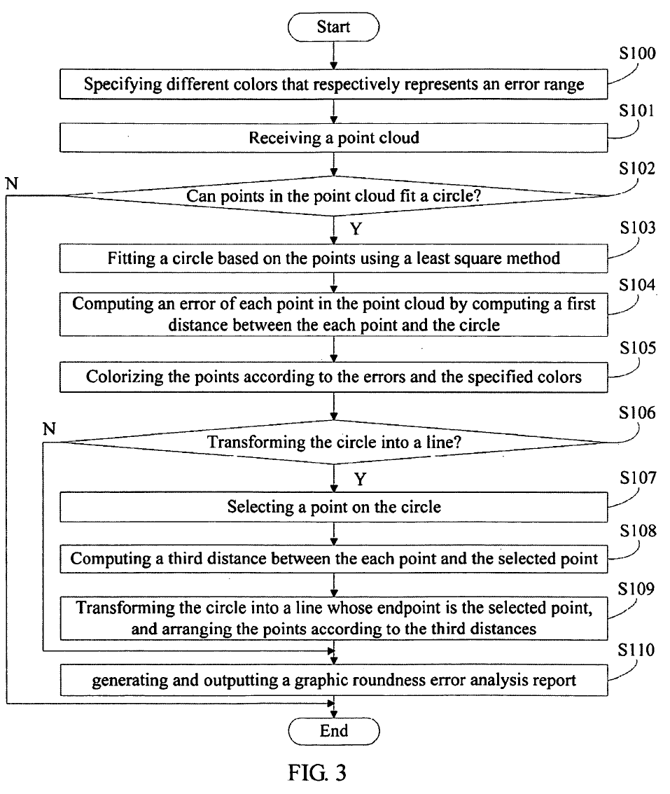

FIG. 3 is a flowchart illustrating one embodiment of a method for computing and displaying a roundness error of an object having circular dimensions on at least one section of the object. Depending on the embodiment, additional blocks in the flow of FIG. 3 may be added, others removed, and the ordering of the blocks may be changed.

In block S100, the colors specifying module 200 specifies a plurality of different colors that represents different error ranges of points. As mentioned above, the color specifying module 200 may specify red for an error range of 0.001 mm-0.005 mm, specify yellow for an error range of 0.006 mm-0.010 mm, and so on.

In block S101, the point cloud receiving module 210 receives a point cloud of the object from the database 1.

In block S102, the determining module 220 determines that if points in the point cloud can fit a circle. If the number of the points in the point cloud is less than 3, or all the points in the point cloud are in a straight line, the points in the point cloud cannot fit a circle, then the flow comes to the end. Otherwise, if the number of the points in the point cloud is more than or equal to 3 and the points in the point cloud are not in a straight line, the points in the point cloud can fit a circle, then the flow moves to block S103.

In block S103, the circle fitting module 230 fits a circle based on the points in the point cloud using a least square method.

In block S104, the distance computing module 240 computes a first distance between each point in the point cloud and the center of the circle, and then computes a second distance by subtracting the radius of the circle from the first distance. It may be understood that, the second distance is an error of the point.

In block S105, the points colorizing module 250 colorizes the points in the point cloud according to the errors of the points and the specified colors. In an example, if an error of a point in the point cloud is 0.004, which falls in the error range of 0.001 mm-0.005 mm, the points colorizing module 250 assigns red to the point. In another example, if an error of a point in the point cloud is 0.007, which falls in the error range of 0.006 mm-0.00 mm, the points colorizing module 250 assigns yellow to the point.

In block S106, the line transforming module 260 determines if the circle need to be transformed into a line based on an operation of a user. The flow moves to block S107 if the circle need to be transformed into a line. Otherwise, the flow moves to block S110 if the circle does not need to be transformed into a line.

In block S107, the line transforming module 260 selects a point on the circle, and splits the circle at the selected point.

In block S108, the line transforming module 260 computes a third distance between each point in the point cloud and the selected point.

In block S109, the line transforming module 260 transforms the circle into a line by pulling the split circle straightly and taking the selected point as an endpoint of the line, and arranges all points in the point cloud round the line according to the third distances.

In block S110, the outputting module 270 generates a graphic roundness error analysis report comprising the specified colors, the circle, the colorized points, the line, and the point cloud, and outputs the graphic roundness error analysis report.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for computing and displaying a roundness error of an object, comprising:
a colors specifying module configured for specifying a plurality of different colors, wherein each of the colors represents a specific error range of points;
a points receiving module configured for receiving a point cloud of the object;
a circle fitting module configured for fitting a circle based on points in the point cloud using a least square method;
a distance computing module configured for computing an error of each point in the point cloud based on the circle;
a points colorizing module configured for colorizing the points in the point cloud according to the errors of the points and the specified colors;
an outputting module configured for generating a graphic roundness error analysis report comprising the specified colors, the circle, the colorized points, and outputting the graphic roundness error analysis report; and
at least one processor that executes the colors specifying module, the points receiving module, the circle fitting module, the distance computing module, the points colorizing module, and the outputting module.

2. The system as described in claim 1, the system further comprising:
a determining module configured for determining if the points in the point cloud can fit a circle.

3. The system as described in claim 1, wherein the error is computed as follows:
computing a first distance between the each point in the point cloud and the center of the circle; and
a second distance by subtracting the radius of the circle from the first distance, wherein the second distance is the error of each point in the point cloud.

4. The system as described in claim 1, the system further comprising:
a line transforming module configured for transforming the circle into a line by selecting a point on the circle as an endpoint of the line, and arranging the points in the point cloud according to a third distance between the each point in the point cloud and the selected point.

5. The system as described in claim 4, wherein the graphic roundness error analysis report further comprises the line and the arranged points.

6. A computer-implemented method for computing and displaying a roundness error of an object, comprising:
specifying a plurality of different colors, wherein each of the colors represents a specific error range;
receiving a point cloud of the object;
fitting a circle based on points in the point cloud using a least square method;
computing an error of each point in the point cloud based on the circle;
colorizing the points in the point cloud according to the errors of the points and the specified colors;
generating a graphic roundness error analysis report comprising the specified colors, the circle and the colorized points; and
outputting the graphic roundness error analysis report.

7. The method as described in claim 6, further comprising:
determining if the points in the point cloud can fit a circle; and
ending the procedure if the points cannot fit a circle.

8. The method as described in claim 6, wherein the computing block comprises:
computing a first distance between the each point in the point cloud and the center of the circle; and
computing a second distance by subtracting the radius of the circle from the first distance, wherein the second distance is the error of each point in the point cloud.

9. The method as described in claim 6, further comprising:
transforming the circle into a line by selecting a point on the circle as an endpoint of the line; and
arranging the points according to a third distance between the each of the points in the point cloud and the selected point.

10. The method as described in claim 9, wherein the graphic roundness error analysis report further comprises the line and the arranged points.

11. A storage medium having stored thereon instructions that, when executed by a processor, causing the processor to perform a method for computing and displaying a roundness error of an object, the method comprising:
specifying a plurality of different colors, wherein each of the colors represents a specific error range;
receiving a point cloud of the object;
fitting a circle based on the point in the point cloud using a least square method;
computing an error of each point in the point cloud based on the circle;
colorizing the points in the point cloud according to the errors of the points and the specified colors;
generating a graphic roundness error analysis report comprising the specified colors, the circle and the colorized points; and
outputting the graphic roundness error analysis report.

12. The storage medium as described in claim 11, wherein the method further comprises:
determining if the points in the point cloud can fit a circle; and
ending the procedure if the points cannot fit a circle.

13. The storage medium as described in claim 11, wherein the computing block comprises:
computing a first distance between each point in the point cloud and the center of the circle; and
computing a second distance by subtracting the radius of the circle from the first distance, wherein the second distance is the error of each point in the point cloud.

14. The storage medium as described in claim 11, wherein the method further comprises:
transforming the circle into a line by selecting a point on the circle as an endpoint of the line; and
arranging the points according to a third distance between each of the points and the selected point.

15. The storage medium as described in claim 14, wherein the graphic roundness error analysis report further comprises the line and the arranged points.
